(19) United States
(12) Patent Application Publication
(10) Pub. No.: US 2018/0313558 A1
(43) Pub. Date: Nov. 1, 2018

(54) SMART CEILING AND FLOOR TILES

(71) Applicant: Cisco Technology, Inc., San Jose, CA (US)

(72) Inventors: Charles Calvin Byers, Wheaton, IL (US); Gonzalo Salgueiro, Raleigh, NC (US); Joseph Michael Clarke, Raleigh, NC (US)

(21) Appl. No.: 15/499,758

(22) Filed: Apr. 27, 2017

(51) Int. Cl. F24F 11/02; E04B 9/04; E04F 15/02; F24F 7/06; H04R 1/40; H04R 3/00; H04R 29/00; H04R 1/02; G03B 29/00; G05B 15/02

(52) U.S. Cl. CPC F24F 11/02; E04B 9/04; E04F 15/02; F24F 7/06; H04R 1/406; F24F 2221/14; H04R 29/00; H04R 1/028; G03B 29/00; G05B 15/02; H04R 3/005

(57) ABSTRACT

In one embodiment, a ceiling tile, configured to be positioned above a given area, comprises a plurality of sensors and a plurality actuators embedded within the ceiling tile, each sensor configured to sense a corresponding feature of the area, and each actuator configured to modify a corresponding feature of the area. The plurality of sensors and plurality of actuators are configured to interact with a controlling device that controls a plurality of ceiling tiles for the area. In another embodiment, one or more floor tiles with one or more sensors (e.g., and actuators) may also be located within the area, and the controlling device further controls the floor tiles, accordingly.

### TECHNICAL FIELD

The present disclosure relates generally to computer networks and sensor fusion, and, more particularly, to smart ceiling and floor tiles.

### BACKGROUND

Indoor spaces have long been the subject of sensor systems, such as thermostats, video cameras, microphones, motion detection, and so on. Safety, convenience, and efficiency of indoor spaces can be greatly improved through the advanced application of sensor technology. Actuators such as heaters, fans, dampers, lights, and video displays also play a role in indoor spaces. For instance, various techniques are emerging with the goal of improving the environment in buildings, such as making light fixtures intelligent, which allows occupants to tailor the illumination in the room space, or making temperature control systems more dynamic and energy efficient. However, the adaptiveness and level of control of current sensor systems are limited.

### BRIEF DESCRIPTION OF THE DRAWINGS

The embodiments herein may be better understood by referring to the following description in conjunction with the accompanying drawings in which like reference numerals indicate identically or functionally similar elements, of which:

FIGS. 1A-1B illustrate example communication networks;

FIG. 2 illustrates an example network device;

FIG. 3 illustrates an example smart ceiling tile;

FIG. 4 illustrates an example smart ceiling (e.g., and floor) tile system;

FIG. 5 illustrates an example control system for a smart ceiling tile (e.g., and floor) system; and

FIG. 6 illustrates an example procedure for operating a smart ceiling tile (e.g., and floor) system.

### DESCRIPTION OF EXAMPLE EMBODIMENTS

Overview

According to one or more embodiments of the disclosure, a ceiling tile, configured to be positioned above a given area, comprises a plurality of sensors and a plurality actuators embedded within the ceiling tile, each sensor configured to sense a corresponding feature of the area, and each actuator configured to modify a corresponding feature of the area. The plurality of sensors and plurality of actuators are configured to interact with a controlling device that controls a plurality of ceiling tiles for the area. In further embodiments, one or more floor tiles with one or more sensors (e.g., and actuators) may also be located within the area, and the controlling device further is controls the floor tiles, accordingly (e.g., operatively coupling ceiling tiles to a corresponding floor tiles below them).

### Description

A computer network is a geographically distributed collection of nodes interconnected by communication links and segments for transporting data between end nodes, such as personal computers and workstations, or other devices, such as sensors, etc. Many types of networks are available, ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links. The Internet is an example of a WAN that connects disparate networks throughout the world, providing global communication between nodes on various networks. The nodes typically communicate over the network by exchanging discrete frames or packets of data according to predefined protocols, such as the Transmission Control Protocol/Internet Protocol (TCP/IP). In this context, a protocol consists of a set of rules defining how the nodes interact with each other.

Smart object networks, such as sensor networks, in particular, are a specific type of network having spatially distributed autonomous devices such as sensors, actuators, etc., that cooperatively monitor physical or environmental conditions at different locations, such as, e.g., energy/power consumption, resource consumption (e.g., water/gas/etc. for advanced metering infrastructure or “AMI” applications) temperature, pressure, vibration, sound, radiation, motion, pollutants, etc. Other types of smart objects include actuators, e.g., responsible for turning on/off an engine moving a component, or performing any other actions. Sensor networks, a type of smart object network, are typically shared-media networks, such as wireless or Powerline Communication (PLC) networks. That is, in addition to one or more sensors, each sensor device (node) in a sensor network may generally be equipped with a radio transceiver or other is communication port, a microcontroller, and an energy source, such as a battery. Often, smart object networks are considered field area networks (FANs), neighborhood area networks (NANs), personal area networks (PANs), etc. Generally, size and cost constraints on smart object nodes (e.g., sensors) result in corresponding constraints on resources such as energy, memory, computational speed, and bandwidth.

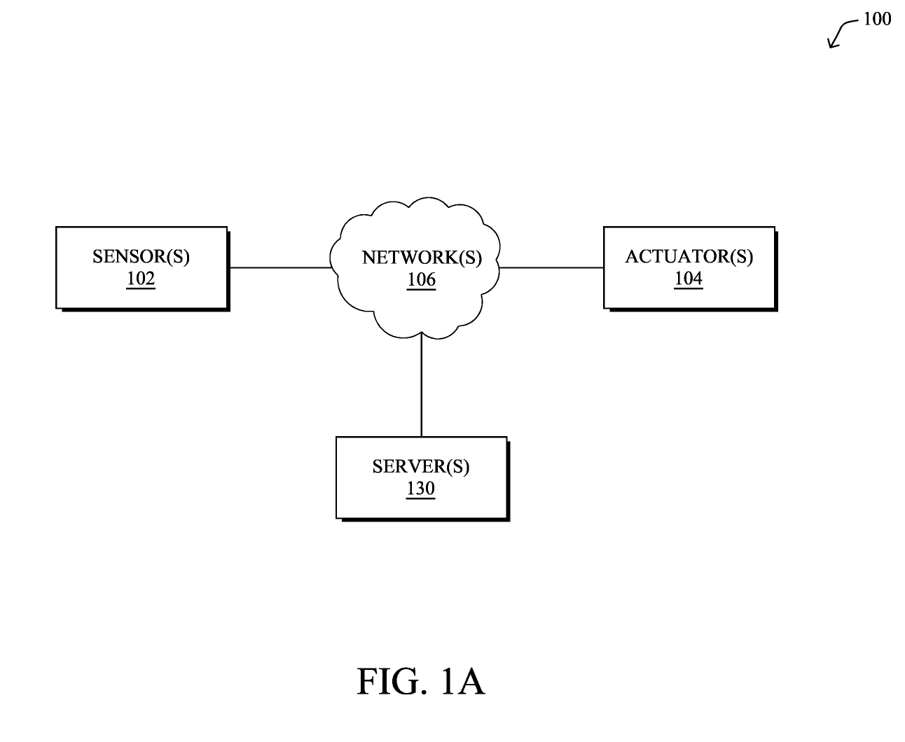

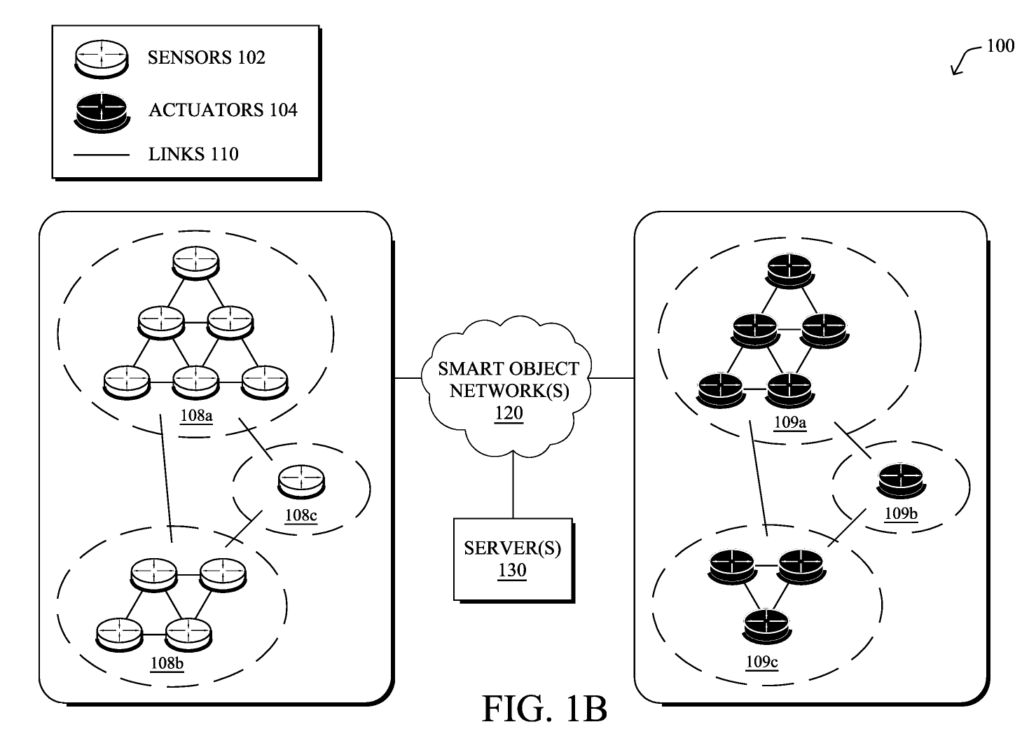

FIG. 1A illustrates an example simplified communication system 100, according to various embodiments of the present disclosure. As shown, network devices, such as sensors 102, may be in communication with another network device, such as an actuator (e.g., of a room system device) 104, via one or more computer networks 106. In certain embodiments, a server 130 may control or assist the communication and/or operation of the sensor(s) 102 and actuator(s) 104. As will be appreciated, network(s) 106 may include, but are not limited to, LANs, WANs, the Internet, cellular networks, infrared networks, satellite networks, or any other form of data network configured to convey data between computing devices, particularly those accessible wirelessly. Network(s) 106 may include any number of wired or wireless links as connections between network devices, as will be appreciated by those skilled in the art. Example wired links may include, but are not limited to, fiber optic links, Ethernet-based links (e.g., Category 5/5e cabling, Category 6 cabling, Power over Ethernet (PoE) links, etc.), coaxial links, PLC links, combinations thereof, or the like. Example wireless links may include, but are not limited to, near field-based links, Wi-Fi links, LiFi (Ethernet over light modulation) links, satellite links, cellular links, free-space optical links, combinations thereof, or the like.

In various embodiments, communication system 100 may be modeled as a mesh network, such as an Internet of Things network. Loosely, the term “Internet of Things” or “IoT” refers to uniquely identifiable objects (things) and their virtual representations in a network-based architecture. In particular, IoT networks provide the ability to connect more than just computers and communications devices, but rather the ability to connect “objects” in general, such as lights, appliances, vehicles, heating, ventilating, and air-conditioning (HVAC), windows and window shades and blinds, doors, locks, industrial equipment, medical devices, etc. The “Internet of Things” thus generally refers to the is interconnection of objects (e.g., smart objects), such as sensors and actuators, over a computer network (e.g., via IP), which may be the public Internet or a private network.

Fog computing, in addition, is a technique wherein the computation, networking, and storage capabilities of cloud computing are moved from central datacenters and relocated to the edge of networks to be much closer to IoT sensors and actuators. This can provide many advantages for critical systems including reduced latency, better security, lower network bandwidth, and improved system reliability

Notably, shared-media mesh networks, such as wireless or PLC networks, etc., are often on what is referred to as Low-Power and Lossy Networks (LLNs), which are a class of network in which both the routers and their interconnect are constrained: LLN routers typically operate with constraints, e.g., processing power, memory, and/or energy (battery), and their interconnects are characterized by, illustratively, high loss rates, low data rates, and/or instability. LLNs are comprised of anything from a few dozen to thousands or even millions of LLN routers, and support point-to-point traffic (between devices inside the LLN), point-to-multipoint traffic (from a central control point such at the root node to a subset of devices inside the LLN), and multipoint-to-point traffic (from devices inside the LLN towards a central control point). Often, an IoT network is implemented with an LLN-like architecture. For example, as shown, communication system 100 may be an LLN in which sensors 102 and actuators 104 operate as nodes/devices in the local mesh, in some embodiments, and optionally in communication with one or more servers 130.

FIG. 1B illustrates an example of communication system 100 in greater detail, according to various embodiments. In particular, as shown in FIG. 1B, communication system 100 may comprise a plurality of network device groups, such as sensor groups 108a, 108b, and 108c. Each group may include one or more network devices, such as sensors 102. As shown, network devices groups may be in communication with each other, with network links 110 providing connectivity between devices and groups. The devices may be proximate to each other or may be located in different areas, such as in different types of local networks. According to various embodiments, as shown, network is device groups may also be in communication, such as through smart object network(s) 120, with network devices of another device group, such as actuator groups 109a, 109b, and 109c, each including actuators 104. In this way, network devices and/or groups may be operationally linked such that the function of one network device or group of network devices may be coordinated with the function of another network device or group.

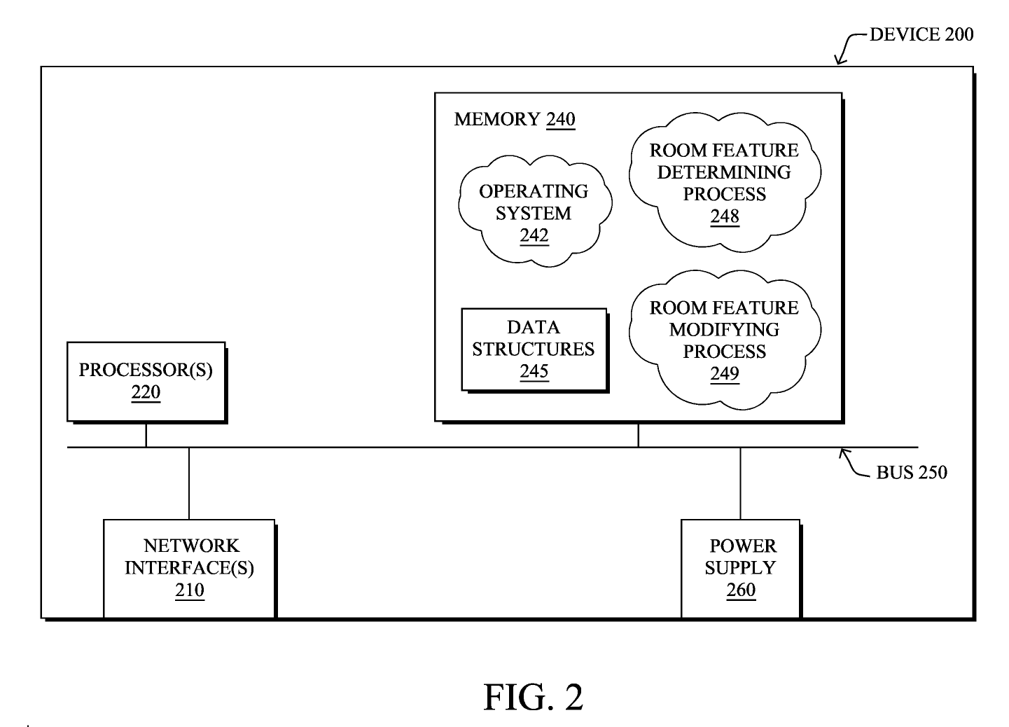

FIG. 2 is a schematic block diagram of an example node/device 200 that may be used with one or more embodiments described herein, e.g., as any of the computing devices shown in FIGS. 1A-1B, particularly sensors 102, actuators 104, servers 130, or any other computing device that supports the operations of communication system 100 (e.g., routers, access points, etc.), or any of the other devices referenced below. The device 200 may also be any other suitable type of device depending upon the type of network architecture in place, such as IoT nodes, Fog devices, etc. Device 200 may include one or more network interfaces 210, one or more processors 220, and a memory 240 interconnected by a system bus 250 and powered by a power supply system 260.

The network interfaces 210 include the mechanical, electrical, and signaling circuitry for communicating data over wireless and/or wired links of communication system 100 (e.g., any number of ports, transceivers, antennas, etc.). The network interfaces may be configured to transmit and/or receive data using a variety of different communication protocols. For example, in one embodiment, network interface(s) 210 may include a wireless interface that supports Wi-Fi, cellular, or other wireless technologies to connect devices 200, such as sensors 102 and/or actuators 104, to a nearby Wi-Fi network, 3G/4G cellular data network, or the like. In another embodiment, network interface(s) 210 include an interface for a hardwired network connection such as a 100 Mb/s Power over Ethernet (PoE) port. This not only provides data interconnect, but can also provide the power needed to run the device over the same physical cable, feeding energy into power supply 260. In another embodiment, network interface(s) 210 may include a near-field communication interface that uses Bluetooth or any of the emerging Internet of Things (IoT) wireless options, to communicatively connect to any is other nearby device.

Memory 240 includes a plurality of storage locations that are addressable by processor(s) 220 and network interfaces 210 for storing software programs and data structures associated with the embodiments described herein. Note that certain devices may have limited memory or no memory (e.g., no memory for storage other than for programs/processes operating on the device and associated caches). Processor 220 may comprise necessary elements or logic adapted to execute the software programs and manipulate data structures 245. Operating system 242, portions of which is typically resident in memory 240 and executed by processor(s) 220, functionally organizes data by, among other things, invoking operations in support of software processors and/or services executing on the devices. Illustratively, these software processors and/or services may include room feature determining process (e.g., sensing process) 248 and/or room feature modifying process (e.g., actuating process) 249 that are configured to perform the operations as described herein.

In general, room feature determining process 248, when executed, may be operable to provide a determination of various environmental features of a room, such as an office, hallway, or open work space. In some embodiments, various devices, such as sensors 102, may be configured to measure and/or monitor various aspects of the environment within a working space, such as light level, sound level, air flow, temperature, etc. In addition, room feature modifying process 249, when executed, may be operable to provide for the setting, modification, and/or control of the features of a room, such as environmental conditions. In some embodiments, various devices, such as actuators 104, may be configured to operate, activate, or modify levels or settings of various room systems, such as HVAC systems (or other heating/cooling/temperature systems), sound or speaker systems, security systems, lights, video displays, etc. During operation, room feature determining process 248 and/or room feature modifying process 249 may also use cloud computing techniques (e.g., centralized processing from one or more remote servers) or fog computing techniques (e.g., extending the cloud computing paradigm to the edges of the network) to, for example, coordinate activity between sensors and actuators. Generally, sensors 102 may be configured with the feature determining process 248, while actuators 104 may be configured with the feature modifying process 249. A server 130, on the other hand, may be configured with both processes 248/249 (e.g., a single process or multiple processes) to determine room features, and to determine how to control/modify the room features, accordingly.

Note that room feature modifying process (e.g., actuating process) 249 may include the computation to close the control loop between sensors and actuators, as described herein. That is, the process 249 may accept sensor readings from feature determining process (e.g., sensing process) 248, calculate a new state based upon those readings, configuration, and information from networks, and then commands actuator process 249 to change a room feature. (Note further that this could be associated with room/building level servers, or may operate on a local fog processor included in each ceiling tile, described below.)

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules configured to operate in accordance with the techniques herein (e.g., according to the functionality of a similar process). Further, while processes may be shown and/or described separately, those skilled in the art will appreciate that processes may be routines or modules within other processes.

As noted above, indoor spaces have long been the subject of sensor systems, such as thermostats, video cameras, motion detection, and so on. In particular, safety, convenience and efficiency of indoor spaces can be greatly improved through the application of IoT techniques. However, the granularity of this approach remains an issue. Resolution between sensor locations and the size of actuator control domains is often too coarse, making individualized control difficult. That is, safety, comfort, convenience, and efficiency of these indoor spaces can be greatly improved if the sensing and control domains were significantly reduced from hundreds of square feet to dozens of square feet or smaller.

For example, depending upon the lighting plan, control over lighting intensity and quality may be based on an individual light fixture, covering on the order of a hundred square feet of building floor space. While this is an improvement over a single light switch for the whole room, it is probably not quite fine enough in resolution for individual occupants, tasks, or objects to have full individual lighting control of their local environment (which may require on the order of −20 square-foot granularity). Beyond lighting, heating/ventilation/air conditioning (HVAC) systems also have granularity challenges. Thermostats typically cover many hundreds of square feet, and in-ceiling ventilation mixing boxes control the temperature of all the air supplied to that area. The granularity is too course, making individualized control difficult, and often result in some occupants being too hot while nearby occupants are too cold. Similar granularity issues exist for security cameras, air sensors, pubic address (PA) speakers, digital displays, Wi-Fi, and many other capabilities of modern buildings.

There is also a dynamic aspect to the granularity of control. As people move about a space, the settings they have selected should move with them, or even ahead of them in anticipation of their movements. Ideally, indoor location services should determine the position, speed and direction of a moving individual (preferably with sub-one-foot precision in near real time), and this information could then be used to ensure that the environmental settings (temperature, light, sensor monitoring, etc.) are set correctly wherever each occupant moves. Light preferences could also follow an individual, adjusting the brightness, color temperature, etc. of the fixtures overhead to their preferences just as they are moving into an area. Temperature settings can anticipate a user's movements, for example by pre-heating or pre-cooling a small portion of the building which is anticipated by the system that the user will soon move into, while leaving the unused portions of a building in a more energy efficient state. Determining of is multiple aspects of the environment of an indoor space simultaneously requires high granularity/resolution along with the coordination of room feature determinations with control over room system functions.

The techniques herein, therefore, provide for a system of smart ceiling tiles and, in some embodiments, corresponding smart floor tiles that provide fine granularity control over the physical and cyber environment of an indoor space. In particular, the techniques described herein may provide at least one tile mounted on the ceiling and/or floor of a room, the tiles including a high density array of multiple sensors groups 108 (sensors 102), with each group including one or more sensor of a particular type. The tiles may further include a high density array of multiple device groups 109 comprising actuators 104 configured to modify or change the features of room space. Close proximity of these multiple sensor and groups provides high granularity, which would not have been previously considered due to expected potential interference of sensor and device functions, and prohibitive cost. One or more sensors and one or more actuators may be operatively coupled in order to measure and make changes to room systems with very high resolution and control.

Specifically, according to one or more embodiments of the disclosure as described in detail below, a ceiling tile (a “smart ceiling tile”), configured to be positioned above a given area, comprises a plurality of sensors and a plurality actuators embedded within the ceiling tile, each sensor configured to sense a corresponding feature of the area, and each actuator configured to modify a corresponding feature of the area. The plurality of sensors and plurality of actuators are configured to interact with a controlling device that controls and coordinates a plurality of ceiling tiles for the area. In further embodiments, one or more floor tiles with one or more sensors (e.g., and actuators) may also be located within the area, and the controlling device further controls and monitors the floor tiles, accordingly (e.g., operatively coupling ceiling tiles to a corresponding floor tiles below them).

Illustratively, certain aspects of the techniques described herein may be performed by hardware, software, and/or firmware, such as in accordance with room feature determination process 248 and room feature modifying process 249, which may include computer executable instructions executed by the processor 220 (or independent processor of interfaces 210) to perform functions relating to the techniques described herein. The illustrated processes may be operable on devices present on one ceiling tile and/or on multiple ceiling tiles or floor tiles, as well as one or more servers 130 (e.g., Fog nodes, HVAC systems/controllers, etc.) to provide a coordinated communication link between the devices associated with room function systems, as described herein.

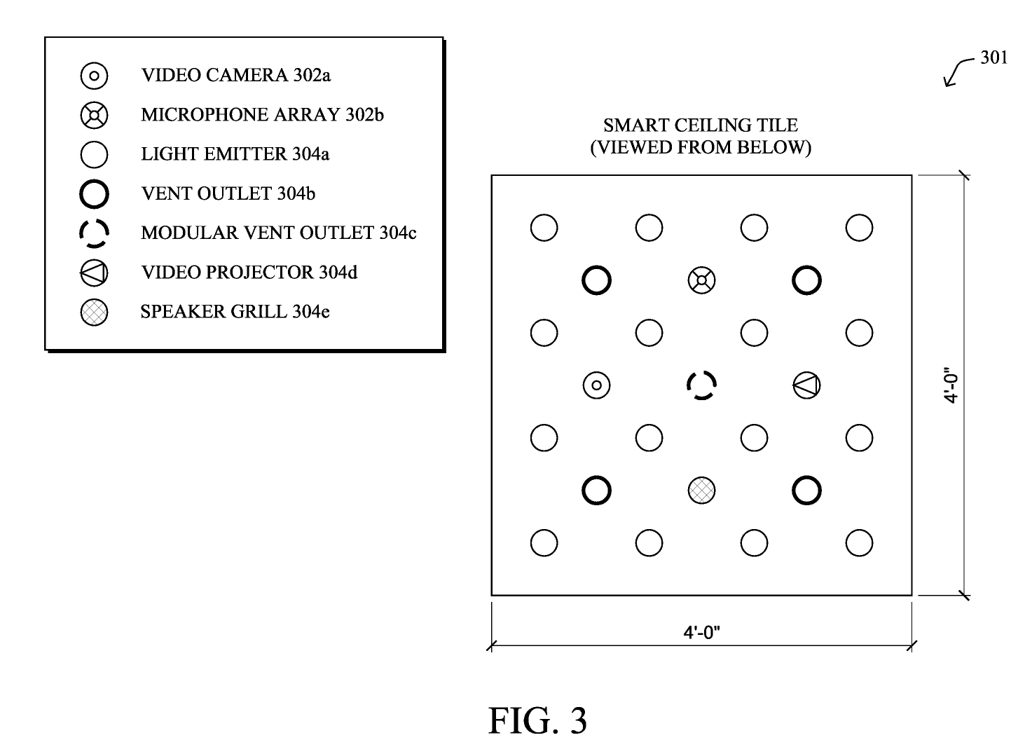

Operationally, FIG. 3 shows an example ceiling tile 301 viewed upwardly from below, according to various embodiments of the present disclosure. As shown, ceiling tile 301 may comprise a plurality of sensor groups (e.g., sensor types), with each group including one or more similar sensors (e.g., a sensor array) configured to determine one or more room features. Examples of sensors include, but are not limited to, light sensors, air flow meters, temperature sensors, air quality meters, hygrometers, security cameras, sound meters, microphones, motion detectors, or wireless access antenna. In the specific example embodiment shown in FIG. 3, ceiling tile 301 comprises two sensor groups, 302a and 302b. Sensor group 302a includes a video camera to monitor the visual status of the space beneath the tile, and sensor group 302b includes a microphone array to measure and monitor the audio status of the space. Each of these groups may, in some embodiments, include multiple sensors of the same type, although only one of each is shown. The relative positioning of each sensor group on the ceiling tile, as well as each sensor in each sensor group, may vary depending, for example, on the size of the tile, the relative size of the sensor, the area of the room space below the tile into which the sensor is focused (e.g., field of view), and so on. In some embodiments, additional or alternative sensor groups, including different sensor types, may be included in the ceiling tile, depending, for example, on which room feature is to be monitored.

As shown in FIG. 3, ceiling tile 301 may further comprise a plurality of device groups (e.g., groups of actuators, groups of sensors, operatively coupled sensor-actuator groups, etc.), with each group comprising one or more actuators configured to alter a is feature of the room space. Examples of such devices include, but are not limited to, light emitters, air vents, agent release vents, projectors, security alarms, speakers, or wireless/LiFi access points. In the example embodiment shown in FIG. 3, ceiling tile 301 comprises actuator groups 304a (light emitters), 304b (vent outlets), 304c (a modular vent outlet), 304d (a video projector), and 304e (a speaker). Additional, fewer, or alternative devices may be used, and the illustrated ceiling tile is merely an example. For instance, in this specific embodiment, center modular vent outlet 304c may be a fifth vent outlet 304b or may be replaced with alternative instruments, such as an exit sign, specialized lighting device, or smoke detector. In addition, the number, type, and location of the actuators may also be varied. The various devices (e.g., actuators, lenses, ducts, etc.) may protrude from the surface of the ceiling tile or may be flush with the surface, as needed for their operation. The room features modified by the actuators of the plurality of device groups may be the same or different than the room features determined (e.g., monitored or measured) by the sensors of the plurality of sensor groups is different from the room features modified by the actuators of the plurality of device groups, as discussed in more detail below. Examples of such room features include, but are not limited to, light level, air flow rate, air temperature, air composition, humidity, security status, sound quality, sound level, room occupancy, wireless access availability, and so on.

One or more of the sensors of the sensor groups and one or more of the actuators of the actuator groups may be operatively coupled (e.g., “sensor-actuator” pairs), in various embodiments of the present disclosure. In this way, conditions determined by the sensors of the sensor group beneath or in the vicinity of the ceiling tile can be communicated to actuators associated with related room systems, which may then be activated and/or controlled (such as by system actuators) to cause a desired output (e.g., to modify the sensed room feature or to modify an unrelated room feature). Example room systems include, but are not limited to, lighting systems, heating/ventilation/air conditioning (HVAC) systems, security systems, visual projection systems, audio systems, electrical systems, or remote data access networks. Closed-loop control systems with real-time or near real-time response can be provided. Various specific embodiments is are described in more detail below.

The ceiling tiles may have a variety of different sizes and overall shapes, depending, for example, on the design of the ceiling and the room space. For example, the ceiling tile may be square, rectangular, polygonal (e.g., pentagonal, hexagonal, etc.), circular, or oval. In the embodiment shown in FIG. 3, ceiling tile 301 may be similar to, but 2-4 times the area of a typical white ceiling tile, such as a 4′×4′ square tile (16 square feet) configured to fit into a standard 4′ on center suspended ceiling grid. Furthermore, the sensor groups and device groups may be configured to cover at least the area beneath the ceiling tile comprising them. For example, for a 4′×4′ square tile (e.g., ceiling tile 301), 16 square feet or more of the floor space below the tile may be monitored by the sensor groups and/or modified by the device groups.

In addition, the density of devices (e.g., the total number of sensors and actuators per unit area) can be varied. In some embodiments, the density of devices is high, such as greater than 1 device/square foot, in order to provide high granularity. In the embodiment shown in FIG. 3, the device density is 1.5. Higher densities are possible depending, for example, on the size, shape, and position of each device. For example, circular devices that are relatively small (e.g., 1 inch in diameter) can be more readily positioned and spaced apart around the ceiling tile, interspersed with sensors of the various sensor groups without interfering with their operation. In some embodiments, all the tiles in a room's ceiling are substantially identical, providing a uniform density of sensors and devices. In other embodiments, different types of smart tiles are used in various interleaved or checkerboard patterns, providing high sensor and device density in some areas, with lower density in others.

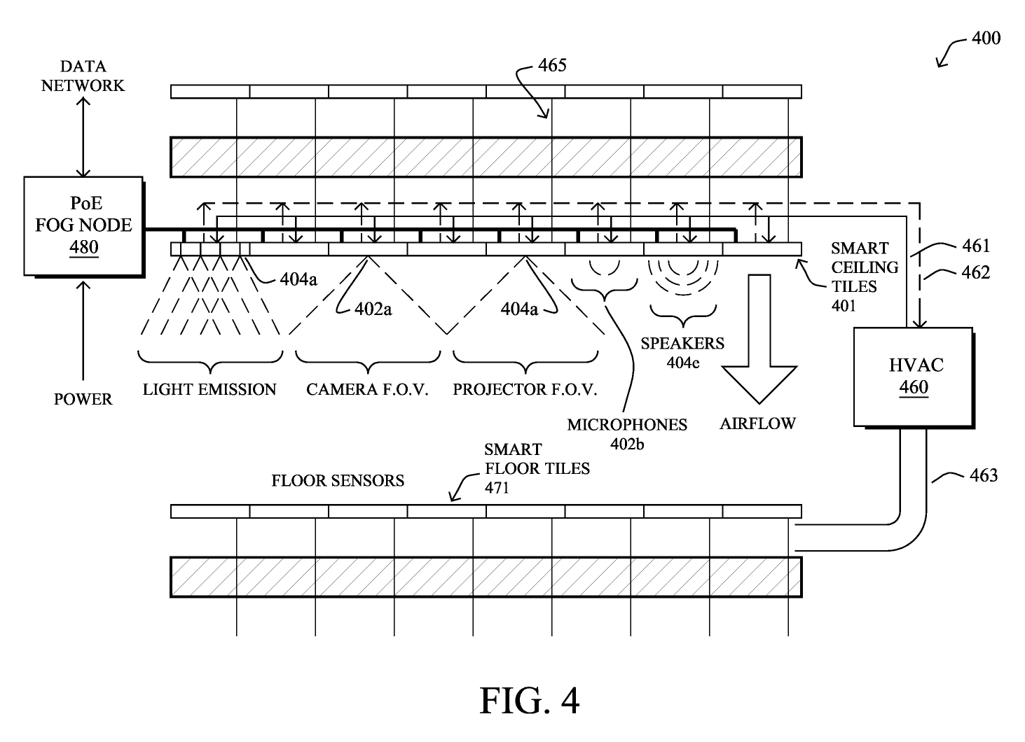

FIG. 4 shows a specific example embodiment of a monitoring system, according to various embodiments of the present disclosure. As shown, monitoring system 400 comprises a plurality of ceiling tiles 401 (e.g., ceiling tile 301), each tile comprising a plurality of sensors 402 and actuators 404 (although not all are shown for each ceiling tile for clarity). The monitoring system, in some embodiments, may be controlled by a room-level fog node 480 (e.g., server 130) in communication with a data network, and may is receive power and data services via a power over Ethernet (PoE) from a much more powerful building-level fog node/PoE switch.

In the specific embodiment illustrated in FIG. 4, eight ceiling tiles are shown in a side view of one floor of a building. Each ceiling tile 401 may include an integrated air mixing box that takes warm air and cool air in controlled proportions from heating/ventilation/air conditioning (HVAC) system 460, arriving through warm air inlet duct 461 and cool air inlet duct 462 from above the ceiling tile. Additional ducts beyond these two could also be provided for air supplies with different humidity levels. The mixing boxes may further include two servo motor controlled dampers to mix arriving air flows in a desired proportion. Thus, in some embodiments, ceiling tiles 401 include one or more actuators (e.g., a set of vents) to achieve a desired room feature (e.g., the required temperature and flow rate) by allowing the mixed air to blow through the vents positioned in the ceiling down into the room. In one embodiment with 4″×4″ tiles, the granularity of control over room temperature is 16 square feet.

In some embodiments, each ceiling tile 401 may further include a plurality of controllable LED emitters 404a as actuators for modifying the general room illumination to a desired brightness, color temperature, color, and/or direction. In some embodiments, micro video projector 404d may also be included in each ceiling tile, capable of modifying the visual aspects of the room by painting the floor, walls, and contents of the room with overlapping high definition images (e.g., the projector field of view (F.O.V)), thereby providing building-scale augmented reality (AR)/virtual reality (VR) capabilities that may be used, for example, to supplement the light emissions from LED emitters 404a. Each ceiling tile may also include, in some embodiments, speaker 404e to create or augment sound fields.

In addition, each ceiling tile 401 may also include one or more cameras 402a as a sensor with a field of view (F.O.V.) wider than the width of the ceiling tile in order to photograph the room from overhead for sensing/detecting motions, gestures, and positions, for identifying people or hazards, etc. as well as an array of microphones 402b is to sense sound levels and/or to listen to directional sounds, enabling building wide interactive voice services, localization, and increased security. Any or all of these sensors may be operatively coupled with one or more of the actuators positioned in the same ceiling tile or in a neighboring ceiling tile.

For example, as is also shown in FIG. 4, the plurality of ceiling tiles of monitoring system 400 are positioned in the room, with some tiles adjacent to others. In some embodiments, sensors and/or actuators of one ceiling tile may be operatively coupled with sensors and/or actuators of an adjacent or neighbor ceiling tile. In this way, the devices may function cooperatively across ceiling tiles. For example, cameras 402a from adjacent tiles may overlap in their field of view, allowing high resolution composite images and 3D sensing capability. In addition, cameras 402a of one ceiling tile may be operatively coupled to speakers 404e in an adjacent ceiling tile, which would enable an individual to be identified while walking through the space to be communicated with while in motion. Other cooperative functions are possible as sensors and actuators are operatively coupled, some of which are described in more detail below.

Furthermore, the monitoring system of the present disclosure may further comprise at least one floor tile positioned below at least one ceiling tile. The floor tiles may also include a plurality of sensors and/or a plurality of sensor groups (e.g., types of sensors) including one or more similar sensors, and, further, may also include a plurality of actuators and/or actuator groups including one or more actuators. The sensors and actuators may be operatively coupled, including to a room system controller. In addition, sensors and actuators may be operatively coupled to sensors and/or actuators of adjacent floor tiles or corresponding ceiling tiles. Also, as shown in FIG. 4, devices in ceiling tiles from one floor of a building may be operatively coupled to floor tiles from the floor above. In this way, the floor tiles 471 can have sensors slaved off of a nearby ceiling tile 401 (such as through cables 465 that penetrate the floor slab in multiple places) without the need for processors or their own PoE ports. This saves cost of electronics, energy, and installation complexity.

For example, as shown in the specific embodiment of FIG. 4, monitoring system 400 may include companion smart floor tiles 471 which may be used in conjunction with smart ceiling tiles 401. Floor tiles may be any shape or size as desired for the room space. As a specific embodiment, floor tiles may be 4′×4′ (similar to the ceiling tiles directly above them) and cover the entire floor of the indoor space. As shown, smart floor tiles 471 may be porous to allow room air to pass through them into underfloor return plenum 463, and thence to HVAC system 460. In some embodiments, sensors positioned in the floor tile can sample the return air to determine air quality, such as humidity, temperature, flow rate, and the presence/concentration of any undesirable contaminants (such as smoke; dust; traces of chemical, biological, radiological, nuclear, or explosive (CBRNE) agents; etc.). Other sensors in the floor tiles may detect floor pressure, light levels, liquid spills, etc. These may form a part of an overall security system, particularly by operatively pairing the floor tiles with ceiling tiles directly above them. Furthermore, an optimal ceiling-to-floor airflow pattern may be produced by positioning floor tiles directly beneath ceiling tiles, which would approach an ideal laminar flow and allow exact control over the environment between them (e.g., within each 16 square-foot portion of the building).

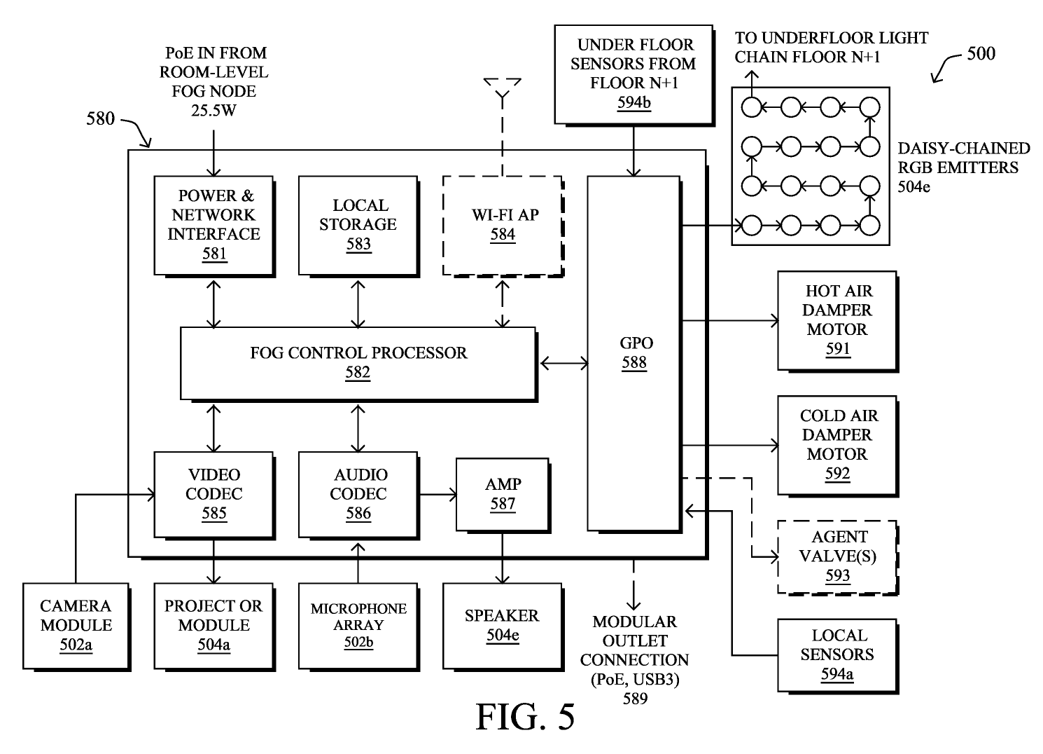

Additional details relating to an embodiment of the monitoring system of the present disclosure are shown schematically in FIG. 5, illustrating the internal details of a single smart ceiling tile (e.g., its local fog node, including processor and peripheral interfaces). As shown, system 500 (e.g., a smart ceiling tile) comprises a plurality of sensor groups and a plurality of actuator groups. For example, the system may include, in one example embodiment, 16 red-green-blue (RGB) light emitters 504e (e.g., LEDs) linked sequentially (e.g., daisy-chained), as well as audio-video input/output (I/O) systems. For instance, audio and video coder/decoder (CoDec) functions 585 and 586 may encode signals from various sensors, such as video from camera module 502a and audio from microphone array 502b, and decodes the signals for use by corresponding actuators to which they may be operatively coupled, such as video decoded for projector module 504a and audio for speaker module 504e (through amplifier 587).

Monitoring system (ceiling tile) 500 further includes control electronics 580 (e.g., in communication with server 130, PoE Fog node 480, etc., above) having components as desired for operation of the various sensors and devices. Control electronics may include, for example, power and network interfaces 581 (e.g., a PoE interface capable of receiving a bidirectional gigabit Ethernet communications channel and approximately 25 W of electrical power from the building-level fog node or PoE switch) and fog control processor 582 having local storage 583 and optional wireless access point (AP) 584. (Note that the PoE port may be connected as a spoke to a room level fog node as a hub.) Control electronics 580 may further include general purpose input/output (GPIO) 588 with an interface logic that adapts the various local sensor and actuator signals into the processor. For example, GPIO 588 may be linked to various actuators of a room HVAC system, such as hot air damper motor 591, cold air damper motor 592, and optional agent valve(s) 593, to control their operation, such as based on input provided by local sensors 594a, sensors and devices from another floor 594b, or fog control processor 582. Control electronics 580 may further include modular outlet connection 589, which can be used for the addition of optional sensors and devices to manage specialized needs in a few areas of a building, or for future expansion.

As described herein, the monitoring system of the present disclosure, in some embodiments includes sensors and/or actuators that are operatively linked to provide functional communication from one to the other. In this way, room features determined by a sensor in a ceiling tile may be used by a actuator (on the same ceiling tile, an adjacent ceiling tile, or a corresponding floor tile) to modify or otherwise alter a related or unrelated room feature.

For example, sensors mounted in the ceiling tiles (including video cameras, microphones, motion detectors, etc.) as well as sensors mounted in corresponding floor tiles (such as pressure detectors) can determine the presence of an individual in the monitored space. Other sensors can determine other features of the room space between the ceiling and floor tiles, such as air quality, temperature, humidity, or air flow rate. The air in the space can then be modified by various actuators based on information determined by the sensors. In particular, in certain optional embodiments, the air mixing box in the ceiling tiles may include a valve and port for the introduction of an “agent” into the outgoing HVAC airflow. Examples of suitable agents include deionized water to add humidity, fire retardants if smoke or excess heat is determined, pleasant scents chosen by marketing if sounds or images associated with particular customer demographics are detected (such as a popcorn smell for children or perfume for women), supplementary oxygen as may be needed, or incapacitating agents (e.g., Capsaicin or tear gas, for example, to disable an active shooter). In the preferred embodiment, each ceiling tile has its own agent valve (or even multiple valves to control multiple agents), so the system can deliver agents only to the nominally 16 square foot areas where the system commands, and deliver no agent to adjacent areas.

As another specific example, ceiling tiles comprising various sensors and further including a plurality of RGB light emitters may be operatively coupled with floor tiles also including a plurality of RGB light emitters. In this way, dynamic floor and ceiling lighting plans for retail and entertainment venues may be produced, which may be based, in part, on one or more sensor determinations of movement in the covered space. Examples of these plans could be discotheque lighting for dance venues, path lighting to guide occupants to destinations, animated images, or emergency evacuation route markers.

As another specific example, ceiling tiles within a defined building space may include a Wi-Fi AP. With Wi-Fi antennas located on a continuous grid of ceiling tiles, coverage in all parts of the building space would be optimal, bandwidth would be practically unlimited, and indoor location services would have a wealth of data to use to determine the locations of all wireless clients in a space with great precision. In addition, RGB LED emitters would be capable of displaying richer diagnostic information about connected WiFi or other environmental aspects of the connected tile than a single LED. Thus, a field technician deployed to a problem area can not only be guided there by the present monitoring system using the connected ceiling and floor tiles but may also get detailed data about the problem once there, with streaming updates becoming available as work on the particular issue progressed. The colored light array can also inform occupants of emergency situations, direct them to exits, and even coordinate across an entire room to act as a low resolution overhead video screen.

Furthermore, sensors and actuators may be operatively linked to provide other functional benefits for a room space. For example, the presence of an individual walking into a building space may be determined by various sensor groups in one or more ceiling tiles (optionally further determined by sensor in corresponding floor tiles), and room lights, sound, and room air temperature may be activated. The individual may then perform various gestures and/or voice commands, detected by other sensors in the same tiles, with a corresponding response from various activated actuators. For example, a hand gesture may be used to lower the light levels, raise the room temperature, increase music volume, change a station, etc. As a specific example, a business, such as a restaurant or bar, may be equipped with ceiling tiles having various sensor and actuator device groups as described herein such that, a patron may speak to place an order, and an indicator light (e.g., a spotlight or visual light display from light emitters and/or image projectors) may be provided at that location when the order is ready to provide direction to the server. Should the patron move after placing the order, the monitoring system may be used to locate them at their new location. Payment may also be made using paired microphones and wireless AP capabilities. Other business, recreational, and security benefits are also possible.

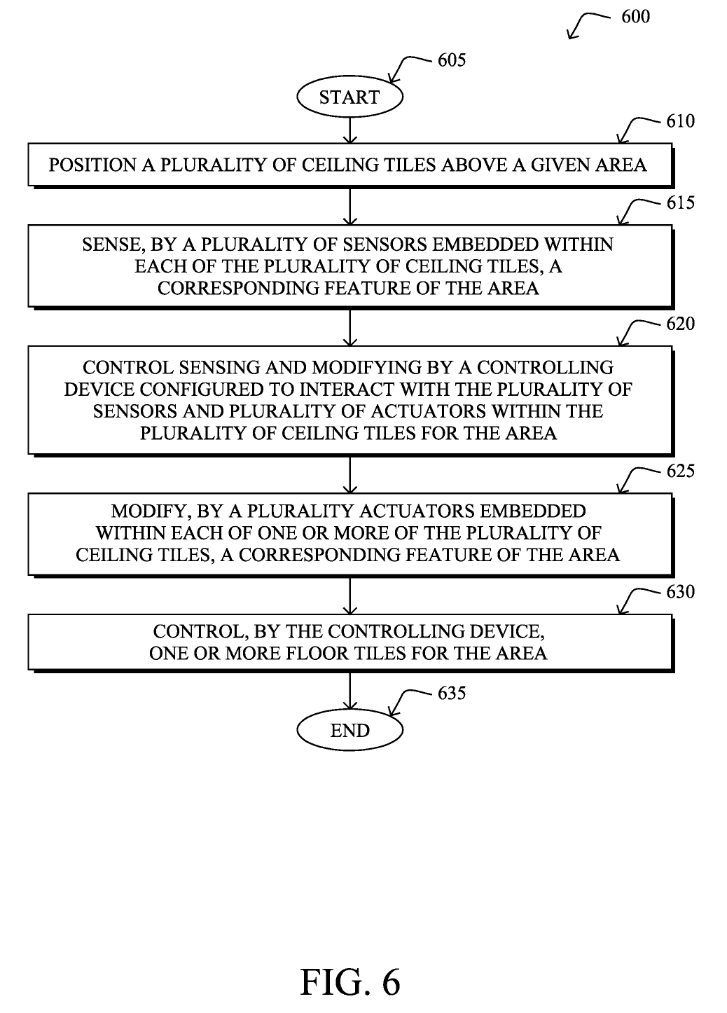

FIG. 6 illustrates an example simplified procedure for operating a smart ceiling tile (e.g., and floor) system in accordance with one or more embodiments described herein. For example, a non-generic, specifically configured device (e.g., device 200, such as a controlling device/controller) may perform procedure 600 by executing stored instructions (e.g., room feature determining process 248 and room feature modifying process 249). The procedure 600 may start at step 605, and continues to step 610, where, as described in greater detail above, a plurality of ceiling tiles 301 are positioned above a given area.

As detailed above, the ceiling tiles have a plurality of embedded sensors 302 and actuators 304 (e.g., where a total device density for the plurality of sensors and plurality of actuators may actually be greater than one device per square foot). As such, in step 615, the plurality of sensors embedded within each of the plurality of ceiling tiles may sense a corresponding feature of the area, and in step 620, a controlling device (e.g., fog node 480, server 580, etc.), configured to interact with the plurality of sensors and plurality of actuators within the plurality of ceiling tiles for the area, controls sensing and modifying as described in greater detail above. For instance, the calculations in step 620 may take sensor readings along with input from nearby tiles, control parameters from server 130, input from the internet and occupant's user interfaces, etc., for consideration in order to derive updated actuator settings. Accordingly, in step 625 the plurality actuators embedded within each of one or more of the plurality of ceiling tiles may modify a corresponding feature of the area. As described above, the features of the area may be a light level, air flow rate, air temperature, air composition, humidity, security status, sound quality, sound level, occupancy, wireless networking, and so on. As such, sensors 302 may be light sensors, air flow meters, temperature sensors, air quality meters, hygrometers, cameras, sound meters, microphones, motion detectors, wireless access antennas, etc. Further, actuators 304 may be light emitters, air vents, agent release vents, projectors, alarms, speakers, wireless transmitters, etc. A closed-loop real-time control system is created, with a loop involving sensors 302, control process, actuators 304 and features of the area.

For instance, one or more of the plurality of sensors or one or more of the plurality of actuators may be operatively coupled to one or more sensors or actuators of an adjacent ceiling tile of the plurality of ceiling tiles and controlled by the controlling device. Further, as described above, the controlling device may also be operatively coupled to one or more other systems, such as a lighting system, a heating/ventilation/air conditioning (HVAC) system, a security system, a visual projection system, an audio system, an electrical system, a building safety system, a data access network, and so on.

Notably, in one or more embodiments as described above, in step 630 the controlling device may further control one or more floor tiles 471 for the area. For instance, one or more of the plurality of sensors or one or more of the plurality of actuators of the ceiling tile may be operatively coupled to one or more sensors or actuators of a particular floor tile for the area that is below the ceiling tile. Example sensors for a floor tile may be things such as air flow sensors, air quality meters, hygrometers, pressure sensors, motion detectors, spill detectors, light sensors, and so on. Actuators may comprise visible displays, tactile (e.g., vibrating) motors, airflow valves (e.g., in one embodiment, the floor tile may also be configured to permit air flow therethrough, as mentioned above), and others. The path from sensing to actuation may involve several system elements. For example, the best location for a local air temperature or air quality sensor may in a floor tile within a room air exhaust port. The floor tile on floor N may be without a processor, but its sensors are slaved off the processor in the ceiling tile immediately below it on floor N−1. That ceiling tile receives the sensor reading from the floor tile sensor, and relays it via network 106 and server 130 to the ceiling tile on floor N immediately above the aforementioned floor tile. That ceiling tile can control its output air parameters and the air flows down to the sensor to keep the air in the space under closed-loop control.

The illustrative and simplified procedure 600 may end in step 635, however the techniques herein may continue to sense and modify features of the area, accordingly.

It should be noted that while certain steps within procedure 600 may be optional as described above, the steps shown in FIG. 6 are merely examples for illustration, and certain other steps may be included or excluded as desired. Further, while a particular order of the steps is shown, this ordering is merely illustrative, and any suitable arrangement of the steps may be utilized without departing from the scope of the embodiments herein.

The techniques described herein, therefore, provide a smart ceiling tile system, optionally having smart floor tiles as well. In particular, the techniques herein provide high granularity control over lighting, HVAC, air quality sensing, etc., which is at least an order of magnitude better than the air handling and sensing systems in traditional smart buildings. Additional embodiments herein allow for new types of control systems (e.g., advanced light control, video input and projection, audio sensing and projection, localized security, etc., as described above). For example, directional microphones being located within about six feet of all occupants allow for high performance voice command systems, and also localizing any sounds that may indicate security concerns (gunshots, screams, etc.) to within a few feet of their origin. Conversely, speakers in each tile can create highly precise sound fields that only the intended listener hears. This is in addition to controlled HVAC airflow coming from each tile that is tailored to the needs of the space it serves immediately below it (e.g., if there are no occupants are there, air flow may be shut off, greatly boosting building efficiency, but if the space is occupied, the preference of the specific occupant can set the exact ratio of warm and cool air to produce the desired temperature).

While there have been shown and described illustrative embodiments that provide smart ceiling tiles having a plurality of sensor/actuator and/or device groups, it is to be understood that various other adaptations and modifications may be made within the spirit and scope of the embodiments herein. For example, while certain embodiments are described herein with respect to using certain sensors and actuators used for specific functions, the techniques herein are not limited as such and may also be used for other functions or combinations of functions, in other embodiments.

The foregoing description has been directed to specific embodiments. It will be apparent, however, that other variations and modifications may be made to the described embodiments, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly this description is to be taken only by way of example and not to otherwise limit the scope of the embodiments herein. Therefore, it is the object of the appended claims to cover all such variations and modifications as come within the true spirit and scope of the embodiments herein.

1. An apparatus, comprising:
a ceiling tile configured to be positioned above a given area;
a plurality of sensors embedded within the ceiling tile, each sensor configured to sense a corresponding feature of the area;
a plurality actuators embedded within the ceiling tile, each actuator configured to modify a corresponding feature of the area; and
an air mixing box integrated in the ceiling tile,
wherein the plurality of sensors and plurality of actuators are configured to interact with a controlling device that controls a plurality of ceiling tiles for the area and a plurality of floor tiles, wherein the controlling device is a fog device.

2. The apparatus as in claim 1, wherein the controlling device further controls one or more floor tiles for the area.

3. The apparatus as in claim 2, wherein one or more of the plurality of sensors or one or more of the plurality of actuators of the ceiling tile are operatively coupled to one or more sensors or actuators of a particular floor tile for the area that is below the ceiling tile.

4. The apparatus as in claim 1, wherein one or more of the plurality of sensors and one or more of the plurality of actuators are operatively coupled.

5. The apparatus as in claim 1, wherein one or more of the plurality of sensors or one or more of the plurality of actuators are operatively coupled to one or more sensors or actuators of an adjacent ceiling tile of the plurality of ceiling tiles controlled by the controlling device.

6. The apparatus as in claim 1, wherein the features of the area are selected from a group consisting of: light level; air flow rate; air temperature; air composition; humidity; security status; sound quality; sound level; occupancy; video imagery; and wireless networking.

7. The apparatus as in claim 1, wherein the plurality of sensors are selected from a group consisting of: light sensors; air flow meters; temperature sensors; air quality meters; hygrometers; cameras; sound meters; microphones; motion detectors; and wireless access antennas.

8. The apparatus as in claim 1, wherein the actuators are selected from a group consisting of: light emitters; air vents; agent release vents; projectors; alarms; speakers; and wireless transmitters.

9. The apparatus as in claim 1, wherein the controlling device is operatively coupled to one or more of a lighting system, a heating/ventilation/air conditioning (HVAC) system, a security system, a visual projection system, an audio system, an electrical system, a building safety system, and a data access network.

10. The apparatus as in claim 1, wherein the ceiling tile has a total device density for the plurality of sensors and plurality of actuators that is greater than one device per square foot.

11. A system, comprising:
a plurality of ceiling tiles configured to be positioned above a given area, wherein each ceiling tile includes an integrated air mixing box;
one or more floor tiles configured to interact in conjunction with the plurality of ceiling tiles, wherein the plurality of floor tiles are porous;
a plurality of sensors embedded within each of the plurality of ceiling tiles and each of the floor tiles, each sensor configured to sense a corresponding feature of the area;
a plurality actuators embedded within each of one or more of the plurality of ceiling tiles, each actuator configured to modify a corresponding feature of the area; and
a fog device configured to interact with the plurality of sensors and plurality of actuators within the plurality of ceiling tiles and the plurality of floor tiles for the area.

12. (canceled)

13. The system as in claim 11, wherein a particular ceiling tile of the plurality of ceiling tiles is operatively coupled to a particular floor tile of the one or more floor tiles that is below the particular ceiling tile.

14. The system as in claim 11, wherein the one or more sensors of the one or more floor tiles are selected from a group consisting of: air flow sensors; air quality meters; hygrometers; pressure sensors; motion detectors; spill detectors; and light sensors.

15. The system as in claim 11, wherein the floor tile is configured to permit air flow therethrough.

16. The system as in claim 11, wherein a first of the plurality of ceiling tiles is operatively coupled to a second of the plurality of ceiling tiles.

17. The system as in claim 11, wherein the features of the area are selected from a group consisting of: light level; air flow rate; air temperature; air composition; humidity; security status; sound quality; sound level; occupancy; and wireless networking.

18. The system as in claim 11, wherein the plurality of sensors are selected from a group consisting of: light sensors; air flow meters; temperature sensors; air quality meters; hygrometers; cameras; sound meters; microphones; motion detectors; and wireless access antennas.

19. The system as in claim 11, wherein the actuators are selected from a group consisting of: light emitters; air vents; agent release vents; projectors; alarms; speakers; and wireless transmitters.

20. A method, comprising:
positioning a plurality of ceiling tiles and floor tiles above and below a given area, wherein each ceiling tile includes an integrated air mixing box;
sensing, by a plurality of sensors embedded within each of the plurality of ceiling tiles and each of the plurality of floor tiles, a corresponding feature of the area;
modifying, by a plurality actuators embedded within each of one or more of the plurality of ceiling tiles, a corresponding feature of the area; and
controlling, by a fog device configured to interact with the plurality of sensors and plurality of actuators within the plurality of ceiling tiles and the plurality of floor tiles for the area, the sensing and modifying.
